(19) United States
(12) Patent Application Publication
(10) Pub. No.: US 2009/0202800 A1
(43) Pub. Date: Aug. 13, 2009

(54) Article With Color Variable Patterns

(76) Inventor: Min-San Huang, Taipei County (TW)

Correspondence Address: SCHMEISER OLSEN & WATTS, 18 E UNIVERSITY DRIVE, SUITE # 101, MESA, AZ, 85201, US

(21) Appl. No.: 12/426,820

(22) Filed: Apr. 20, 2009

Related U.S. Application Data
(63) Continuation-in-part of application No. 11/605,251, filed on Nov. 29, 2006, now abandoned.

(51) Int. Cl. B32B 29/00

(52) U.S. Cl. 428/211.1; 428/195.1

(57) ABSTRACT

A article with color variable patterns comprises a carrier having one printed surface; a pattern layer disposed on the printed surface and including a plurality of color blocks fixed thereon to form at least one color patterns, each color block including a number of color areas with different colors; and a plurality of refraction lenses mounted on the pattern layer; wherein the refraction lens is transparent and includes a top end of a cross section which is formed in a semi-circle shape, and a centrally vertical height h of the refraction lens is more than a radius length r thereof.

This application is a Continuation-in-Part of application Ser. No. 11/605,251, filed Nov. 29, 2006.

### BACKGROUND OF THE INVENTION

1. Field of the Invention

The present invention relates to an article with color variable patterns that can generate different viewing effects as being viewed at different angles by using a plurality of refraction lenses which are disposed on the color variable patterns.

2. Description of the Prior Art

Many clothes or home fabrics have various accessorizing designs. A conventional method is attaching patterns thereon. Patterns can be attached on a clothes by various processing methods, such as embroidering or transferring, etc, to present a particular design style for satisfying various needs of consumers.

To highlight visual effects of the patterns, colors, materials and processing manners of the patterns are all important factors which can affect the visual effects. Therefore, many fabricants take efforts to study the visual effects of the patterns, and new designs of the patterns continually emerge.

However, patterns attached on clothes are static state designs, so that styles and colors of the patterns only have differences in shapes observing from different viewing angles. Therefore, the patterns themselves still show similar, single, stiff impressions to observers.

U.S. Pat. No. 6,856,462 (hereafter called '462) discloses that a lenticular imaging system includes a substrate printed on at least one surface and having patterns formed thereon, a plurality of refraction lenses mounted on the patterns to generate 3D variable effect; wherein on cross sections of the refraction lenses are formed a semi-circular dot or a semi-circular line, thus generate 3D variable effect from different viewing angles.

As shown in FIG. 1, the refraction lens is shaped in a semi-circle and contains a vertical height h and a radius length r, and a red block R and a blue block B are fixed on two sides of the lens, wherein the radius length r is equivalent to or less than the vertical height h (e.g. r h).

With reference to FIGS. 2A-2D, as viewing angle is from 0 degree at a central point of the fraction lens (as shown in FIG. 1) to 10 degrees, 20 degrees, 30 degree, and 45 degrees at a right side of the refraction lens, viewed rates of B1 and R1 are variable with different viewing angles. In other words, as the viewed angle at the right side above the refraction lens becomes increased gradually, the rate of B1 increases but that of the R1 decreases obviously.

As illustrated in FIG. 2D, as the viewing angle is 45 degrees at the right side above the lens, R1 refracting from the red block R is quite slight but B1 refracting from the blue block B is large. In other words, as the viewing angle is over 45 degrees, R1 can be viewed nothing, yet only B1 can be viewed.

Accordingly, as the refraction lens is designed to r=h or r>h, the variable viewing effect is not obvious.

### SUMMARY OF THE INVENTION

The primary object of the present invention is to provide an article with color variable patterns that obtains obviously color-variable rate even through viewing at a slightly inclined angle.

An article with color variable patterns in accordance with the present invention comprises:

a carrier having one printed surface;

a pattern layer disposed on the printed surface and including a plurality of color blocks fixed thereon to form at least one color patterns; and

a plurality of refraction lenses mounted on the pattern layer to cover the color blocks and separated from each other;

wherein the refraction lens is transparent and a top end of a cross section thereof is formed in a semi-circle shape, a centrally vertical height h of the refraction lens is more than a radius length r thereof;

wherein the color block is formed in a circle shape and includes at least two circular color areas which are divided equally and printed different colors respectively, and the top end of the cross section of the refraction lens is formed a dot shape;

wherein the color block is formed in an elongated strap shape and includes at least two elongated color areas with different colors respectively, the top end of the cross section of the refraction lens is formed a line shape;

wherein the top end of the cross section of the refraction lens can be formed in a column shape or a semi-oval shape like a circular bullet.

### BRIEF DESCRIPTION OF THE DRAWINGS

FIG. 1 is a cross sectional view showing a conventional refraction lens having a vertical height h and a radius length r, and h being equivalent to r;

FIGS. 2A-2D are a cross sectional view showing a color variation of a conventional refraction lens as viewing from different angles;

FIG. 3 is an enlarged side view of a pattern attached on a clothes in accordance with the present invention;

FIG. 4 is a top plan view of a color block being covered by a dot-shaped refraction lens in accordance with a first embodiment of the present invention;

FIG. 5 is a cross sectional view of the color block being covered by an elongated-strap shaped refraction lens in accordance with a second embodiment of the present invention;

FIGS. 6A-6C are a cross sectional view of a color block being covered by an elongated-strap refraction lens;

FIG. 7 is a cross sectional view of a refraction lens having a vertical height h and a radius length r (h=1⅓r), being covered by the refraction lens;

FIGS. 8A-8D are a cross sectional view showing a color variation of the refraction lens of FIG. 7 as being viewed from different angles;

FIG. 9 is a cross sectional view of a refraction lens having a vertical height h and a radius length r (h=1⅔r), being covered by the refraction lens;

FIGS. 10A-10D are a cross sectional view showing a color variation of the refraction lens of FIG. 9 as being viewed from different angles;

FIG. 11 is a cross sectional view of a refraction lens having a vertical height h and a radius length r (h=2 r), being covered by the refraction lens;

FIGS. 12A-12D are a cross sectional view showing a color variation of the refraction lens of FIG. 11 as being viewed from different angles.

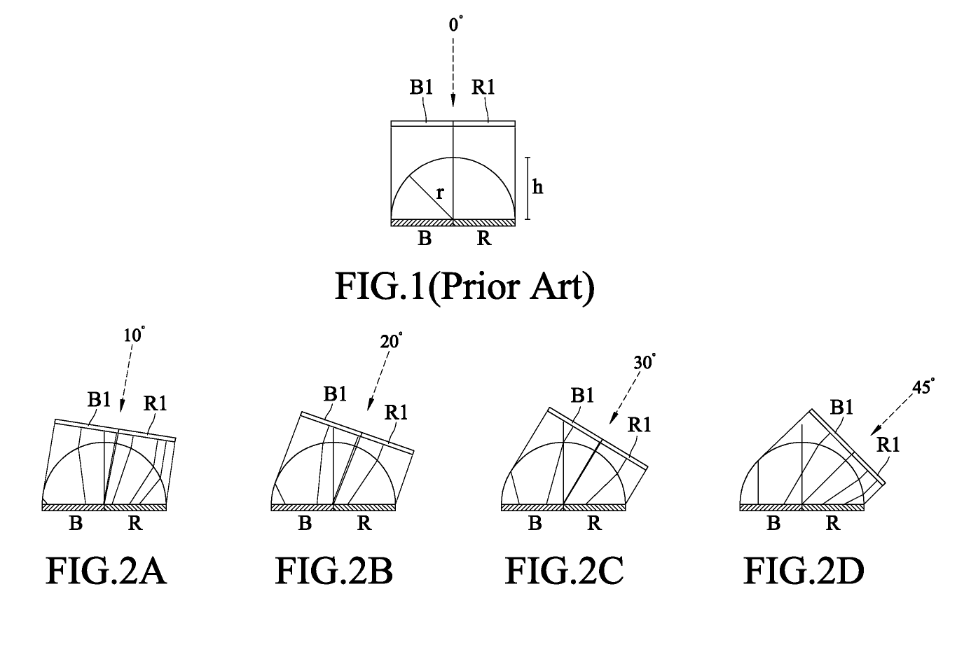

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

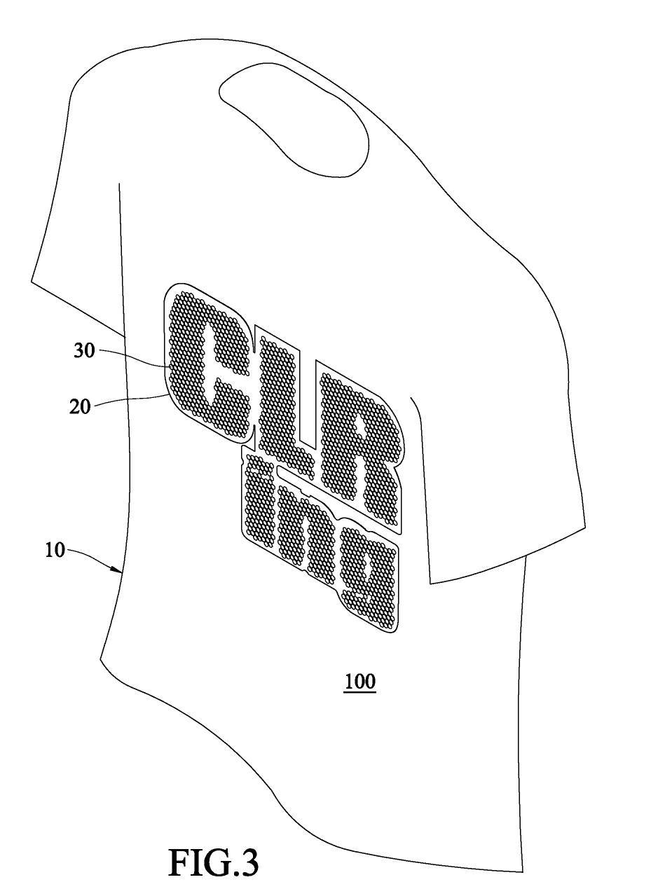

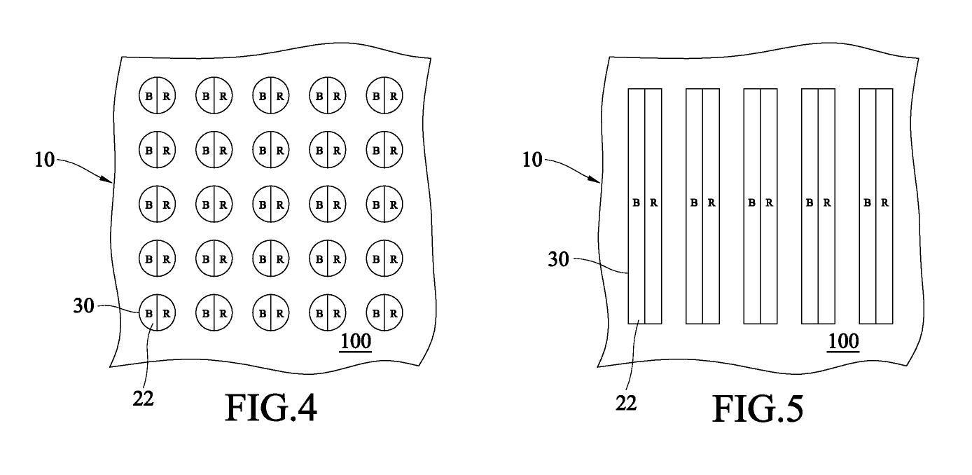

Referring to FIGS. 3-4, an article with color variable patterns in accordance with the present invention comprises a carrier 10 having at least one printed surface 100, a pattern layer 20 disposed on the printed surface 100 by using printing or transfer printing, and a plurality of refraction lenses 30 mounted on the pattern layer 20, wherein

the carrier is not limited to a clothes or paper and the like soft article, it can be a container and the like hard article. The pattern layer 20 includes a plurality of color blocks 22 fixed thereon to form at least one colorful pattern and separated respectively. Each color block 22 includes at least two color areas with different colors, and the refraction lens 30 includes a top end of a cross section which is formed in a semi-circular dot shape, a centrally vertical height h of the refraction lens is more than a radius length r thereof. Besides, the refraction lens 30 is selected from transparent rubber, transparent plastic and transplant glass lenses.

As shown in FIG. 4, the color blocks 22 are formed in a circle shape and each color block 22 includes a plurality of circular color areas which are divided equally and printed different colors respectively, wherein the color areas contains a blue region B and a red region R, and the refraction lens 30 is covered on the color block 22.

Referring to FIG. 5, the color block 22 is formed in an elongated strap shape, and includes two elongated color areas with different colors. The color area includes a blue region B and a red region R. A top end of a cross section of the refraction lens 30 is formed in a line shape, and the refraction lens 30 is covered on the color block 22 with the blue region B and the red region R.

In the embodiment of the present invention, the top end of the cross section of the refraction lens 30 can be formed in a semi-column shape or a semi-oval shape like a bullet.

In the following embodiments of the present invention, the top end of the cross section of the refraction lens 30 is in semi-circle shape, and the centrally vertical height h of the refraction lens 30 is more than a radius length r thereof. It is to be noted that a centrally vertical line is to be used as an origin, wherein a viewing effect for the viewing angle is more than 45 degrees at a right side above the refraction lens 30 is not be discussed here. Because a distance d between the refraction lenses 30 on the carrier 10 are not large enough to display obvious viewing effect due to the refraction lenses are shield by their adjacent ones, therefore the color variable viewing effect is not obvious.

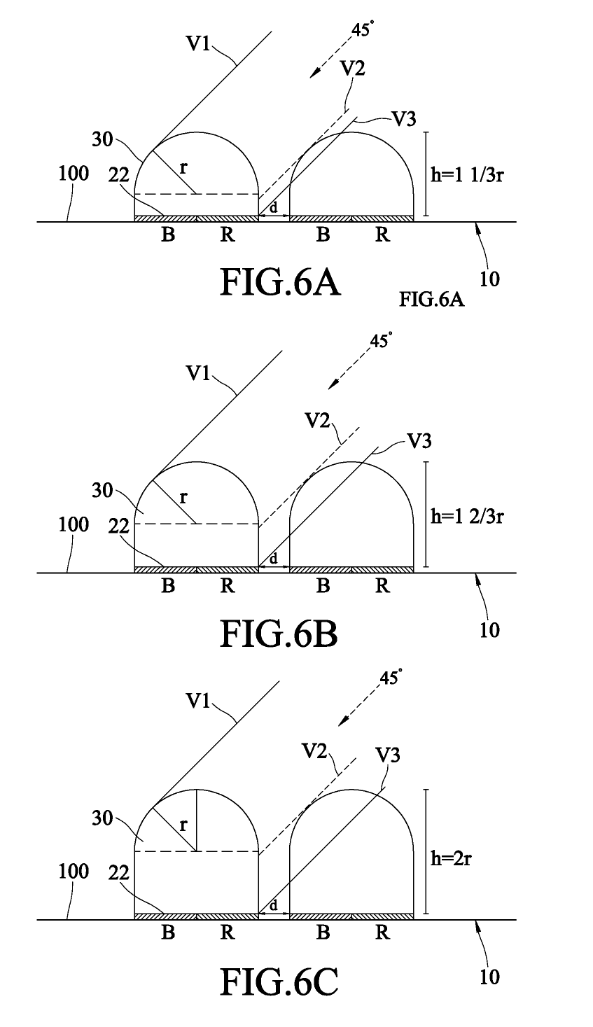

As illustrated in FIGS. 6A-6C, two adjacent refraction lenses 30 are located on the color block 22 of the carrier 10, the top end of the cross section of each refraction lens 30 is in a semi-circle shape, and the centrally vertical length h are 1.33, 1.66, and times larger than the radius length r (e.g. h=1⅓r, ⅔r, and 2 r) respectively, wherein if the distance d between the two refraction lenses 30 is one half time of a radius of the top end of the refraction lens 30 (e.g. d=½r), and as the viewing angle is over 45 degrees, the color refracting range is V1 to V3, but the range V2 to V3 is shielded by the adjacent refraction lens, therefore only the range from V1 to V2 can be viewed. In other words, under the condition of d=½r and the viewing angle is over 45 degrees, the shielded range become more but the viewed range is constant.

As illustrated in FIGS. 6A-6C, if the distance d are the same, as the centrally vertical height h become larger, the shielded viewing range is larger relatively. Besides, if the rate between h and r is constant, as the distance d between two adjacent refraction lenses become smaller, the viewed angle become smaller. On the contrary, as the distance d between two adjacent refraction lenses become larger, the viewed angle become larger.

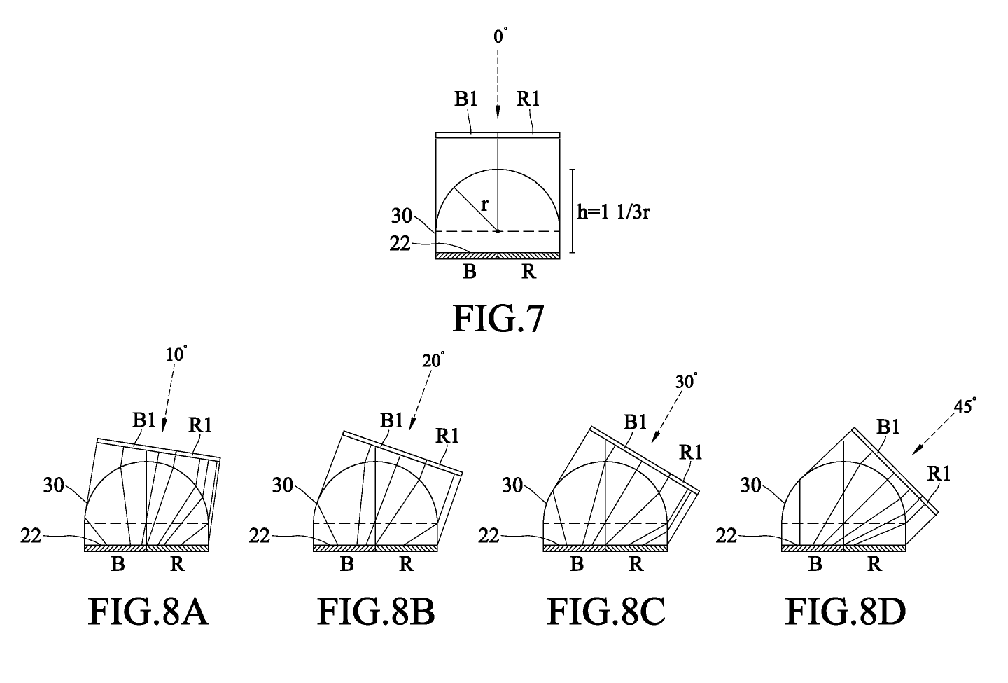

Referring to FIG. 7, as the top end of the cross sectional of the refraction lens 30 is in a semi-circle shape, and the centrally vertical length h is 1.33 times larger than the radius length r (e.g. h=1⅓r). As viewing angle is from 0 degree above the fraction lens 30 (as shown in FIG. 7) to 10 degrees (as illustrated in FIG. 8A), 20 degrees (as illustrated in FIG. 8B), 30 degree (as illustrated in FIG. 8C), and 45 degrees (as illustrated in FIG. 8D) at a right side of the refraction lens 30 (the centrally vertical line is an origin), the viewed rates of the B1 and R1 are variable with the gradually increasing inclined angle.

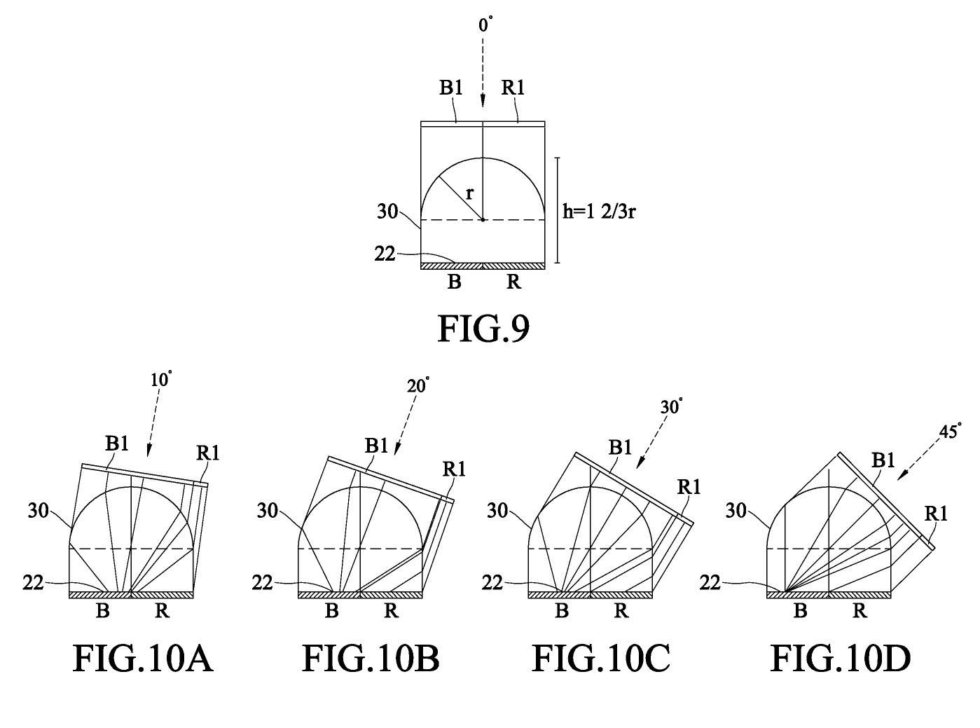

Referring to FIG. 9, as the top end of the cross sectional of the refraction lens 30 is in a semi-circle shape, and the centrally vertical length h is 1.66 times larger than the radius length r (e.g. h=1⅔r). As viewing angle is from 0 degree above the fraction lens 30 (as shown in FIG. 9) to 10 degrees (as illustrated in FIG. 10A), 20 degrees (as illustrated in FIG. 10B), 30 degree (as illustrated in FIG. 10C), and 45 degrees (as illustrated in FIG. 10D) at a right side of the refraction lens 30 (the centrally vertical line is an origin), the viewed rates of the B1 and R1 are variable with the gradually increasing inclined angle.

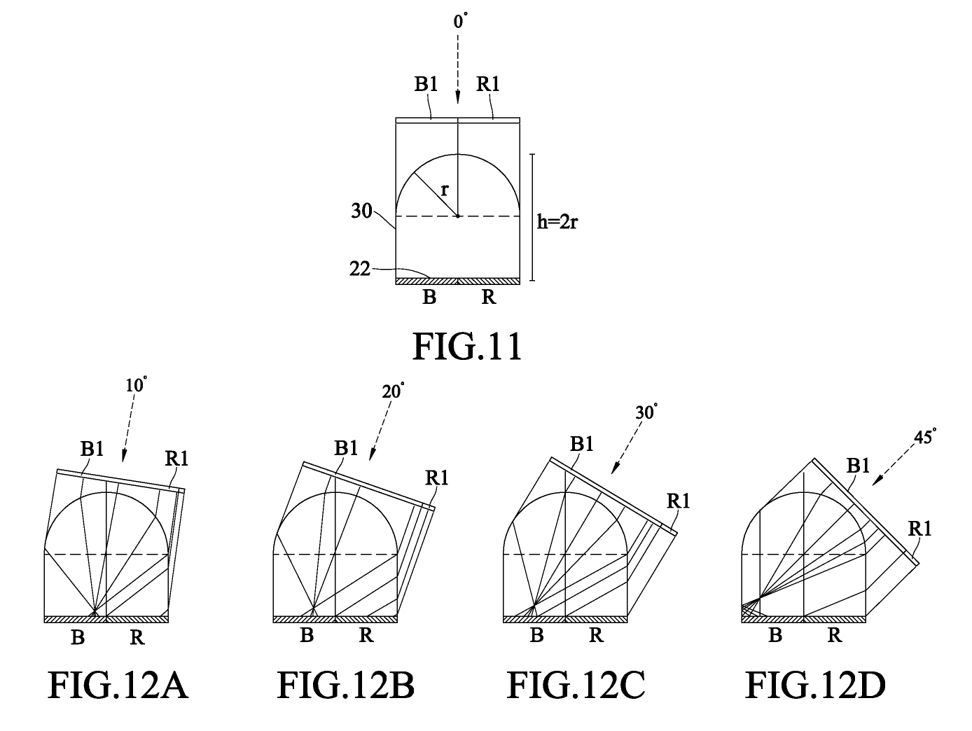

Referring to FIG. 11, as the top end of the cross sectional of the refraction lens 30 is in a semi-circle shape, and the centrally vertical length h is 2 times larger than the radius length r (e.g. h=2 r). As viewing angle is from 0 degree above the fraction lens 30 (as shown in FIG. 11) to 10 degrees (as illustrated in FIG. 12A), 20 degrees (as illustrated in FIG. 12B), 30 degree (as illustrated in FIG. 12C), and 45 degrees (as illustrated in FIG. 12D) at a right side of the refraction lens 30 (the centrally vertical line is an origin), the viewed rates of the B1 and R1 are variable with the gradually increasing inclined angle.

On the contrary, as the viewing angle is 10 degrees, 20 degrees, 30 degree or 45 degrees at a left side above the refraction lens 30, the viewed rates of the B1 and R1 are variable, wherein as the viewing angle becomes increased, the rate of B1 decreases but that of the R1 increase relatively.

From abovementioned descriptions, as the centrally vertical height h is more than the radius length r, the viewing colors are variable obviously from smaller viewing angles. In other words, as the radius length r is fixed and the centrally vertical height h is increased gradually, the viewing effect is variable obviously.

As shown in FIGS. 8A, 10A, and 12A, as the viewing angle is 10 degrees at the right side, the rates of B1 and R1 is varying. Taking FIG. 8A for example, as the viewer views the refraction lens 30 from 0 degree over the refraction lenses 30 to 10 degrees at the right side, the rate of B1 to R1 is variable from 1:1 to 2:1, viewing variation becomes obvious. As shown in FIG. 10A, as the viewer views the refraction lens 30 from 0 degree over the refraction lenses 30 to 10 degrees at the right side, the rate of B1 to R1 is variable from 1:1 to 10:1, viewing variation becomes obvious. As shown in FIG. 12A, as the viewer views the refraction lens 30 from 0 degree over the refraction lenses 30 to 10 degrees at the right side, the rate of B1 to R1 is variable from 1:1 to 24:1, viewing variation becomes obvious.

While we have shown and described various embodiments in accordance with the present invention, it is clear to those skilled in the art that further embodiments may be made without departing from the scope of the present invention.

What is claimed is:

1. An article with color variable patterns comprising:
a carrier having one printed surface;
a pattern layer disposed on the printed surface and including a plurality of color blocks fixed thereon to form at least one color patterns, each color block including a number of color areas with different colors; and
a plurality of refraction lenses mounted on the pattern layer to cover the color blocks and separated from each other respectively;
wherein the refraction lens is transparent and a top end of a cross section thereof is formed in a semi-circle shape, and a centrally vertical height h of the refraction lens is more than a radius length r thereof.

2. The article with color variable patterns as claimed in claim 1, wherein the carrier is a soft article, the soft article can be selected from a clothes with the printed surface and a paper with the printed surface.

3. The article with color variable patterns as claimed in claim 1, wherein the carrier is a hard article with the printed surface.

4. The article with color variable patterns as claimed in claim 1, wherein the clock block is formed in an elongated strap shape.

5. The article with color variable patterns as claimed in claim 4, wherein the clock block includes two elongated color areas with different colors.

6. The article with color variable patterns as claimed in claim 4, wherein the top end of the cross section of the refraction lens is formed in a semi-circular line shape.

7. The article with color variable patterns as claimed in claims 1, wherein the color block is formed in a circle shape.

8. The article with color variable patterns as claimed in claims 7, wherein the color block includes at least two color areas with different colors.

9. The article with color variable patterns as claimed in claims 7, wherein the top end of the cross section is formed in a semi-circular dot shape.

10. The article with color variable patterns as claimed in claims 1, wherein the cross section of the refraction lens is formed in a column shape with a semi-circular top end.

11. The article with color variable patterns as claimed in claims 1, wherein the cross section of the refraction lens is formed in a semi-oval shape with a semi-circular top end.
